(19) United States
(12) Patent Application Publication
(10) Pub. No.: US 2012/0048654 A1
(43) Pub. Date: Mar. 1, 2012

(54) Self-Climbing Material Hoist

(75) Inventor: Grant Steward, New South Wales (AU)

(73) Assignee: Consep Pty Limited, Wetherill Park NSW (AU)

(21) Appl. No.: 13/264,168

(22) PCT Filed: May 20, 2010
(86) PCT No.: PCT/AU2010/000591

§ 371 Date: Oct. 13, 2011

(30) Foreign Application Priority Data
May 21, 2009 (AU) 2009902325
May 22, 2009 (AU) 2009902359

(51) Int. Cl. B66B 9/00; B66B 7/02; B66B 9/06; B66B 11/02

(52) U.S. Cl. 187/245; 187/401; 187/408; 187/250

(57) ABSTRACT

A hoisting device for the transfer of formwork and other construction materials that does not require cutting and welding of the guide rails for assembly and disassembly on site, yet does not pose the difficulties of transporting and handling the fixed span of a full length guide rail. The hoisting device also offers advantages in the transfer materials along floors of buildings that do not follow a vertical line, and in allowing the hoist car to access “green” slabs that are yet to attain full strength.

### FIELD OF THE INVENTION

The present invention relates to hoisting devices and in particular to hoisting devices for use in the construction industry.

The invention has been developed primarily for use as a hoisting device for transferring formwork and other construction materials between levels of a multilevel building. However, it will be appreciated that the invention is not restricted this particular field of use.

### Copyright Notice

This document is subject to copyright. The reproduction, communication and distribution of this document is not permitted without prior consent from the copyright owner, other than as permitted under section 226 of the Patents Act 1990.

### BACKGROUND

Vertical handling of formwork and other construction materials on multilevel building construction sites presents difficulties. Various devices are available to cater for vertical handling of materials, each with different capability and versatility.

One such device is the self-climbing formwork hoist, which has the advantages of not requiring support from the ground or the floors below its span of operation and not requiring the site crane to climb the building line vertically. This enables quick re-sitting of the device on the building and minimises interference with the performance of facade works while the device is installed.

Conventional self-climbing formwork hoists such as U.S. Pat. No. 3,207,263 comprise guide rails that span the collective height of several building floors in a generally upright position. These guide rails are difficult to transport and carry on a standard semitrailer. As a result, the guide rails are typically cut to allow transport on a standard semitrailer and the two halves are then re-welded on site. This is time consuming, causes structural weakening and results in unnecessary waste as every re-use of the hoist results in material being cut away from the guide rails.

The fixed length of the guide rails also poses disadvantages in handling, including difficulties in installing the hoist car at height. The car is mounted onto the device from the upper end of the guide rails when they are in the upright position. This poses handling and safety difficulties as the installation must take place several floors up from ground level.

Yet another disadvantage of conventional formwork hoists that have fixed length guide rails is the difficulty or inability to service sloped or irregularly-shaped building faces, which increases reliance on cranes for vertical handling of construction materials. Cranes cannot be used during wet and windy conditions.

There is a need for hoisting device for vertical handling of formwork and other construction materials that can be easily disassembled to facilitate transport and handling, yet be assembled without the need for welding on site. It would be also an advantage to have a hoisting device that could be used on irregularly shaped buildings or buildings with a sloped face.

### SUMMARY OF THE INVENTION

It is an object of the present invention to provide a hoisting device for the transfer of formwork and other construction materials that does not require cutting and welding of the guide rails for assembly and disassembly on site, yet does not pose the difficulties of transporting and handling the fixed span of a full length guide rail. It is a further object to provide a hoisting device for use on irregularly shaped or inclined buildings (i.e. buildings with a sloped face).

According to an aspect of the invention there is provided a hoisting device for transferring formwork and other construction materials between levels of a multilevel building, the hoisting device including:

(a) a pair of substantially parallel guide rails capable of being secured to a multilevel building so that the guide rails span one or more levels of a building along its height; wherein each guide rail comprises two or more rail sections joined end to end, wherein adjacent rail sections are joined by a reversible connection assembly, thereby allowing the length of the guide rail to be reversibly adjusted by adjusting the number of rail sections joined to form the respective guide rail; and

(b) a hoist car assembly mounted on said the pair of guide rails, wherein the hoist car assembly is slidingly engaged with the guide rails such that the hoist car assembly is moveable along the building height.

According to another aspect of the invention there is provided a hoisting device for transferring formwork and other construction materials between levels of a multilevel building, the hoisting device including:

(a) a pair of substantially parallel guide rails, wherein each guide rail comprises two or more rail sections joined end to end, wherein adjacent rail sections are joined by a reversible connection assembly, thereby allowing the length of the guide rail to be reversibly adjusted by adjusting the number of rail sections joined to form the respective guide rail, the guide rail being configured to span one or more levels of a building along its height;

(b) a hoist car assembly mounted on the pair of guide rails, wherein the hoist car assembly is slidingly engaged with the guide rails such that the hoist car assembly is moveable along the building height; and

(c) a securing element for securing each guide rail to a building, wherein the securing element enables pivotal engagement of each guide rail relative to the building such that the guide rail is adjustable between a substantially vertical position and an inclined position, the inclined position being at an angle to the vertical such that the hoisting device is capable of operating in an inclined position.

The reversible connection assembly allows assembly and disassembly without welding and cutting of the guide rails, respectively. It also permits the length of the guide rails to be reversibly adjusted by adjusting the number of rail sections joined to form each guide rail. This facilitates handling of the guide rails and thereby the hoisting device. Thus the invention in one embodiment provides a hoisting device that overcomes the problem of requiring cutting and welding of guide rails for assembly and disassembly on site. It also provides a hoisting device with adjustable length guide rails thereby improving ease of handling.

In another embodiment, the hoisting device is also able to operate in an inclined position (i.e. tilted or at an angle to the vertical). This is achieved by the securing element enabling pivotal engagement of each guide rail relative to the building so that the guide rail is reversibly adjustable between a substantially vertical position and an inclined position (i.e. on an angle to the vertical).

### BRIEF DESCRIPTION OF THE DRAWINGS

A preferred embodiment of the invention will now be described, by way of example only, with reference to the accompanying drawings in which:

FIG. 1 shows two side views of a hoisting device installed on a multilevel building according to a preferred embodiment.

FIG. 1A shows the hoist car assembly at the lowermost building level spanned by the hoisting device.

FIG. 1B shows the hoist car assembly of FIG. 1B at the uppermost building level accessible using the device.

FIG. 2 shows a front view of the hoisting device shown in FIG. 1, seen from the exterior of the building.

FIG. 3 shows close up detail of the reversible connection assembly of the hoisting device of FIG. 1.

FIG. 3A is a side view of two adjoining rail sections 150, 160 forming a guide rail 110.

FIG. 3B is a detail view of the connection assembly 140 in a preferred embodiment.

FIG. 3C is a cross section of the same assembly 140, taken at line X-X.

FIG. 4 shows front and side views of the hoist car assembly according to two embodiments of the hoisting device.

FIG. 4A is a front view of the hoist car assembly of the hoisting device of FIG. 1.

FIG. 4B is a side view of the same hoist car assembly as shown in FIG. 4A, with the hoisting device in a substantially vertical position.

FIG. 4C is a side view of an embodiment of the hoist car assembly, with the hoisting device in an inclined position. This embodiment is reversibly adjustable between an inclined position and a substantially vertical position.

FIG. 5 are side views in cross section of a retaining shoe of the securing element of the embodiments of FIG. 4, securing a guide rail of the hoisting device to a building floor.

FIG. 5A shows the hoisting device of FIG. 4A in a vertical position.

FIG. 5B shows the hoisting device of FIG. 4C in an inclined position.

FIG. 6 are side views of the embodiment shown in FIG. 4C in an inclined position.

FIG. 6A shows the hoist car assembly at the lowermost building level spanned by the embodiment.

FIG. 6B shows the hoist car assembly at the uppermost building level accessible using the device.

FIG. 7 is a side view of the embodiment of FIG. 1 positioned on a multilevel building. The hoist car can service a level above the uppermost level of support on a building.

### DETAILED DESCRIPTION

The self-climbing material hoisting device described herein provides a new or alternative hoisting device having guide rails comprising a plurality of rail sections, in which adjacent rail sections are joined by a reversible connection assembly so that the guide rails do not require cutting and welding on site for assembly and disassembly. In one embodiment, the hoisting device is also able to operate in an inclined position (i.e. tilted or at an angle to the vertical).

A preferred embodiment of the present invention will now be described by way of non-limiting example only, with reference to the accompanying drawings. The following detailed description in conjunction with the figures provides the skilled addressee with an understanding of the invention. It will be appreciated, however, that the invention is not limited to the applications described below.

### Preferred Embodiments

The figures illustrate a hoisting device including guide rails comprising one or more rail sections, wherein adjacent rail sections are capable of being joined end to end, the sections being joined by a reversible connection assembly.

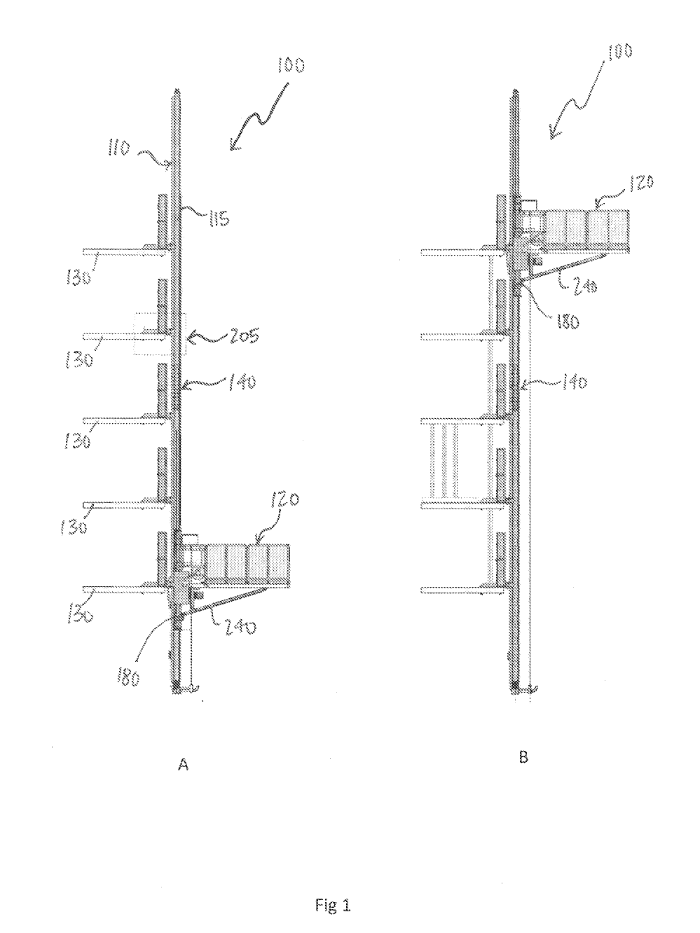

Referring to FIG. 1, two side views (A, B) are shown of a hoisting device 100 according to a preferred embodiment. The device includes a pair of substantially parallel guide rails 110 (only one shown) upon which is mounted a hoist car assembly 120. The guide rails span one or more floors 130 of a multilevel building—typically, several floors as shown in FIG. 1. FIG. 1A shows the hoist car assembly at the lowermost floor spanned by the hoisting device 100. FIG. 1B shows the same hoist car assembly at the uppermost floor spanned by the hoisting device 100.

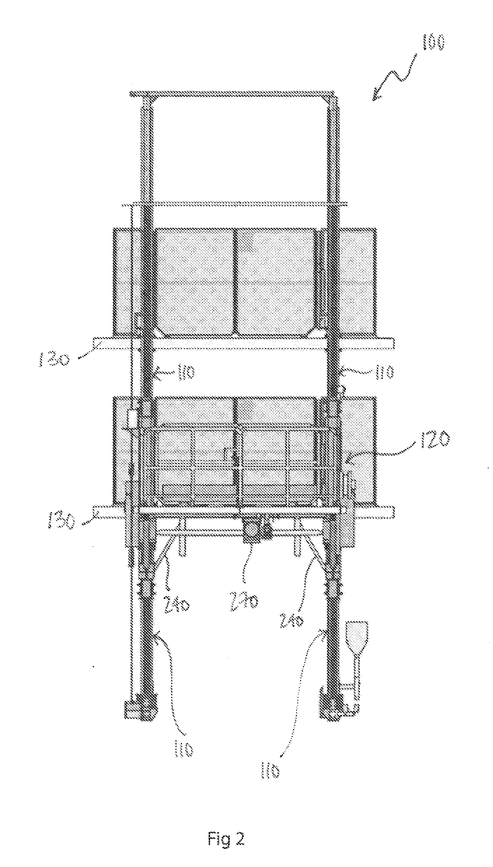

FIG. 2 is a front view of the hoisting device 100 of FIG. 1, seen from the exterior of the building. The mounting of the hoist car assembly 120 on the guide rails 110 can be seen.

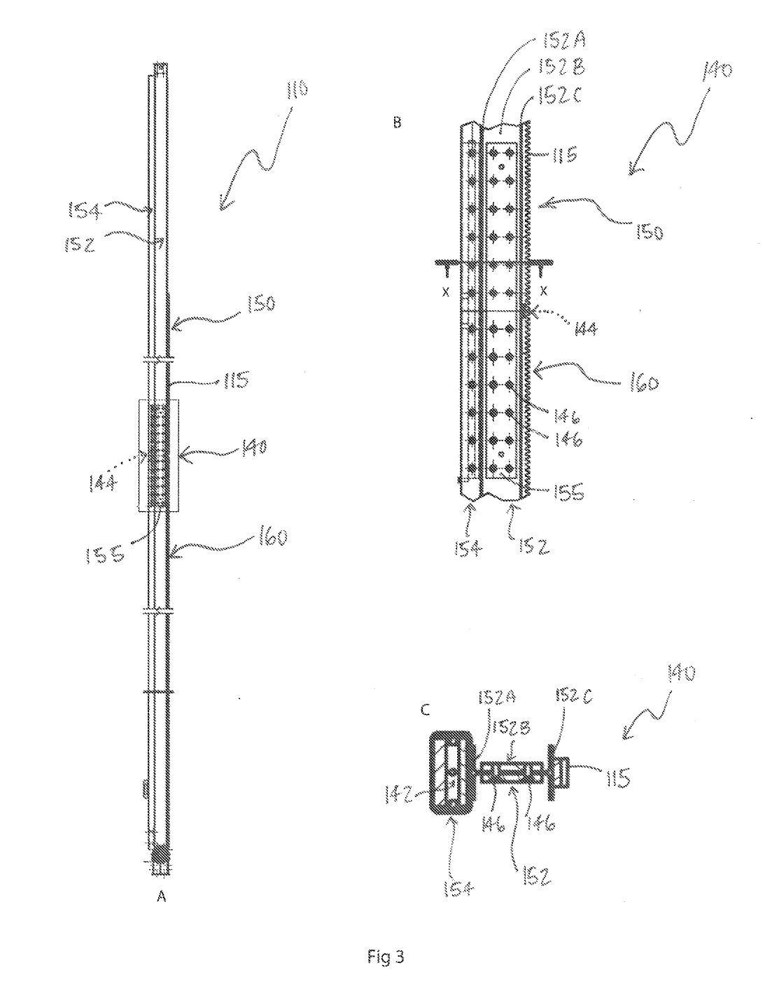

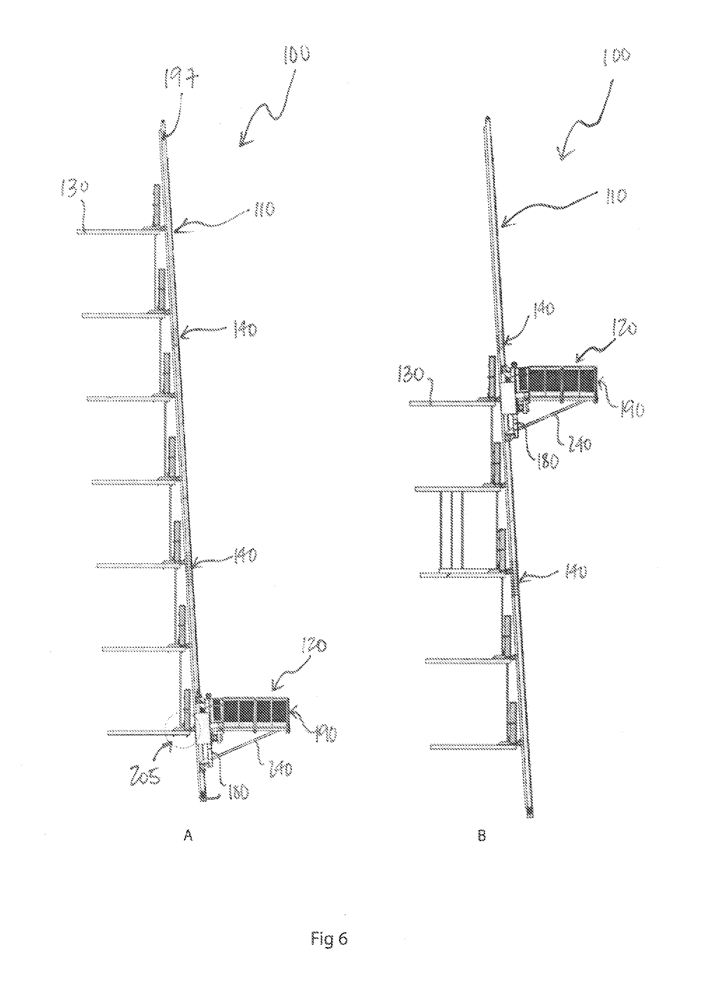

The reversible connection assembly of the guide rails is labelled 140 on FIGS. 1 and 6, and is shown in greater detail in FIG. 3. FIG. 3A shows two adjoining rail sections joined by a connection assembly 140 to form a guide rail 110. The lower rail section is labelled 160 and the upper rail section is labelled 150. In one embodiment, each rail section is formed by an I-beam (or universal beam) 152 secured (e.g. welded) to a box girder 154 along one of the flanges 152A of the I-bean 152—see FIG. 3B. The I-beam 152 and box girder 154 are secured together along their respective longest dimensions, thereby forming a rail section.

FIG. 3B is a detail view of the reversible connection assembly 140 in a preferred embodiment. FIG. 3C is a cross section of the same reversible connection assembly 140, taken at line X-X. A spigot 142 inserts inside the adjacent ends of two rail sections 150, 160 to be joined to secure the box girders together. A retaining plate 155 bridges the joined ends 144 (show in ghost) of adjacent webs 152B of adjacent I-beams 152 and retains the joined ends 144 of the adjacent rail sections 150, 160 together. The retaining plate securing means (illustrated as bolts 146 in FIG. 3) is countersunk within the web 152B of the rail sections 150, 160 enabling smooth passage of the hoist car assembly across the connection assembly.

By using a reversible connection assembly 140 to join adjacent rail sections 150, 160 to form a guide rail 110, the length of the guide rail 110 is reversibly adjustable. This is achieved by adjusting the total number of rail sections joined end-to-end to make up the total length of the guide rail 110.

The adjustable length of the guide rail 110 and relative ease of assembly and disassembly (without cutting and welding on site) overcomes the difficulties in handling fixed full-length guide rails and enables different total lengths of the guide rail to be utilised on site, as needed. For example, referring to FIG. 6, it can be seen that two reversible connection assemblies 140 are illustrated, so that the guide rail 110 comprises three rail sections joined end to end. This improves the versatility of the hoisting device 100 to service different parts of the site.

The reversible connection assembly 140 also enables installation of the hoist car assembly 120 onto the guide rails 110 when only a single rail section is in position. The hoist car assembly 120 is mounted onto the device from the upper end of the guide rail 110. In conventional hoisting devices, this poses handling and safety difficulties as the installation must take place several floors up from ground level. Operation of the preferred embodiment is safer to perform at the height of a single rail section (i.e. a shortened guide rail 110), thereby facilitating assembly and improving safety.

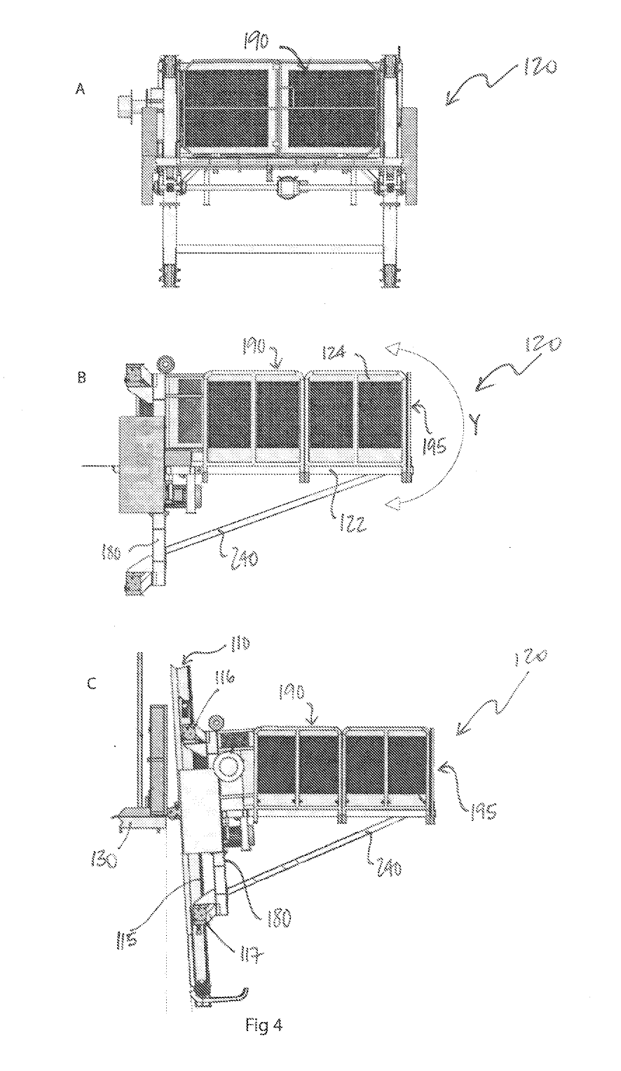

Referring to FIG. 4, front (A) and side (B, C) views of the hoist car assembly 120 are shown. The hoist car assembly 120 includes a pair of mast members 180 on each side of the hoist car 190, at the front car portion of the hoist car 190 (the part of the hoist car closest to the building). The mast members 180 are slidingly engaged with the guide rails and a loading platform or hoist car 190 having a floor 122 and walls 124. The floor 122 extends from the front car portion to the back car portion (the part of the hoist car 190 extended furthest from the building—see item 195 in FIG. 4). The arrangement of the mast members 180 relative to the guide rails 110 is also seen in FIG. 1. Relative sliding movement of the mast members 180 and the guide rails 110 (sliding up or down) enables the hoist car 190 to travel along the length of the guide rails 110, thereby transporting construction materials along the length (i.e. height) of a building.

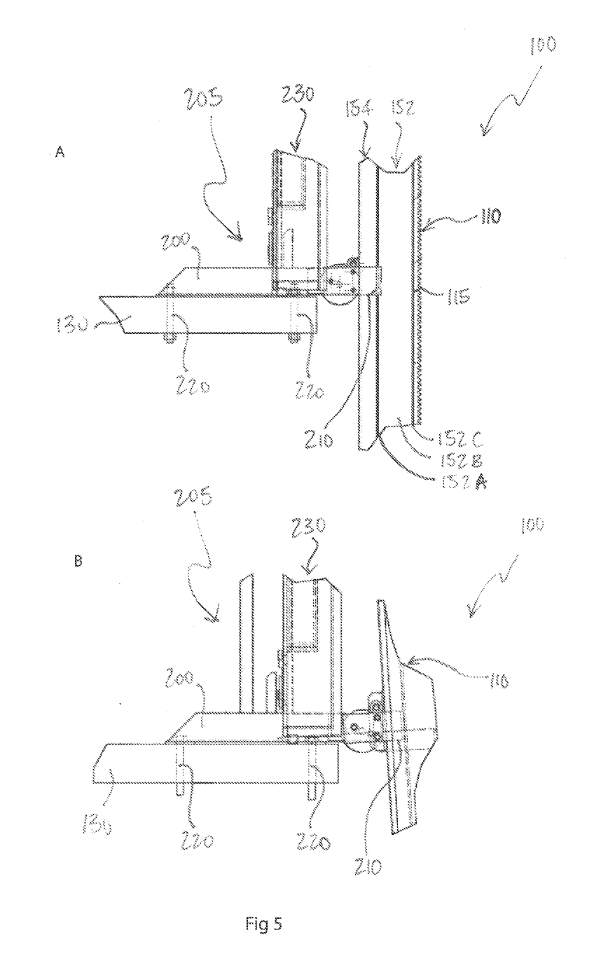

A tooth rack 115 (also seen in FIGS. 3 and 5) runs along the innermost flange 153C of the rail section I-beam 152. The tooth rack 115 provides traction for the hoist car assembly 120 as it travels along the guide rail 110. Referring to FIG. 4C, the tooth rack 115 assists grip by a wheel/roller in each of an upper track wheel housing 116 and a lower track wheel housing 117 on the upper and lower portions of the hoist car assembly 120, respectively.

Conventional formwork hoists such as U.S. Pat. No. 3,207,263 are designed so that the guide rails are kept fixed vertically (i.e. perpendicular in relation to the building floors). This limits operation of conventional hoisting devices to vertical-face buildings. By contrast, the hoisting device in a preferred embodiment (see FIG. 4C) is configured to operate in a vertical or inclined position (“inclined” being sloped or angled relative to the vertical). This enables the hoisting device to climb inclined buildings. This is achieved by the securing element enabling pivotal engagement of each guide rail relative to the building so that the guide rail is reversibly adjustable between a substantially vertical position and an inclined position (i.e. on an angle to the vertical). Because the guide rails are in sections, this also enables the hoisting device to operate on irregularly-shaped buildings.

The preferred embodiment includes a securing element to secure the device to the perimeter edge of a building. Referring to FIG. 5A, the securing element 205 of the preferred embodiment is a plurality of retaining shoes 200 spaced along the length of each guide rail 110, each retaining shoe 200 being capable of being secured to the perimeter edge of a concrete slab of a building floor 130. FIG. 1 includes side views of a retaining shoe 200 securing a guide rail of the hoisting device to a building floor 130. The hoisting device 100 is secured to the floor of a building 130 in a substantially vertical position (i.e. perpendicular to the building floor 130).

The retaining shoe 200 is secured to the perimeter edge of a building floor by bolts 220 (see FIG. 5). The retaining shoe 200 includes a shoe clamp plate 210 at the perimetral portion of the retaining shoe 200 (i.e. the portion of the retaining shoe 200 closest to the perimeter edge of the building). The guide rail 110 is secured to the retaining shoe 200 via the shoe clamp plate 210. The item labelled 230 is a safety gate or landing gate which is electronically interlocked to the hoist car and through which the hoist car can be accessed from the building floor.

FIG. 5B shows that the guide rail 110 can be secured to the shoe clamp plate 210 on an angle to the vertical allowing the device in the embodiment illustrated to operate in an inclined position. The shoe clamp plate 210 is reversibly adjustable relative to the retaining shoe. Adjusting the shoe clamp plate 210 relative to the retaining shoe 200 enables the guide rail to be reversibly adjustable between a substantially vertical position and an inclined position (that is, on an angle to the vertical). In one arrangement, the shoe clamp plate 210 is pivotally engaged with the retaining shoe 200 such that movement of the shoe clamp plate 210 relative to the retaining shoe 200 results in adjustment of the guide rail 110 between a vertical position and an inclined position relative to the building floor.

FIG. 6 shows the hoisting device in an inclined position secured to a building. The back car portion (the part of the hoist car 190 extended furthest from the building—see item 195 in FIGS. 4B and C) can be reversibly tilted to the required angle for climbing an inclined or vertical building as needed. The direction of tilting of the hoist car 190 is indicated by the double-headed arrow Y in FIG. 4B, which shows a hoisting device in a substantially vertical position. In FIG. 4C, the hoisting device is in an inclined position. The dashed line in FIG. 4C indicates the vertical position, at right angles to the building floor 130. While the guide rails 110 and mast members 180 incline away from the vertical, the hoist car 190 is pivotable so that it remains substantially parallel with the floor of the building 130 while the hoist car 190 climbs an inclined tower. FIG. 4C and FIGS. 6A and B show how the hoist car 190 remains parallel with the building floor 130 when the guide rail 110 inclines away from the vertical.

The embodiment illustrated in FIG. 6 offers the ability to service irregularly shaped or inclined buildings (buildings with a sloped face) and overcomes the limitation of conventional formwork hoists that are fixed vertically, which increase reliance on cranes for vertical handling of construction materials. Cranes cannot be used during wet and windy conditions. The preferred embodiment of FIG. 6 can be operated in wet and windy conditions because the hoisting device is secured close to the building.

Also shown in FIG. 6 is the adjustability of the total guide rail length (through the use of reversible connection assemblies 140 on the guide rails 110). This increases the versatility of the preferred embodiment, because relatively shorter or longer total rail guide lengths can be used on inclined or vertical sections as required.

The general arrangement of the features of the preferred embodiment illustrated by the figures shows that the hoist car assembly 120 is braced from its underside. Referring to FIG. 1, a bracing member 240 can be seen underneath the hoist car assembly 120, to support the outward portion of the car from below. This can be seen in closer detail in FIG. 4C. The bracing member 240 in a preferred embodiment is a compression beam. One end of the bracing member 240 engages the back car portion 195 of the hoist car assembly 120 (the part that extends furthest from the line of the building). The other end of the bracing member 240 secures to the mast member 180 on the same side of the hoist car assembly 120. The angled bracing member 240 supports the underside of the hoist car 190, providing sufficient support for the hoist car 190 to travel along the guide rails 110 beyond the uppermost level of a support structure (a floor above) on a building. An overtravel cam assembly 197 prevents the hoist car 190 from travelling too far along an unsupported span of a guide rail 110 beyond the uppermost level of support.

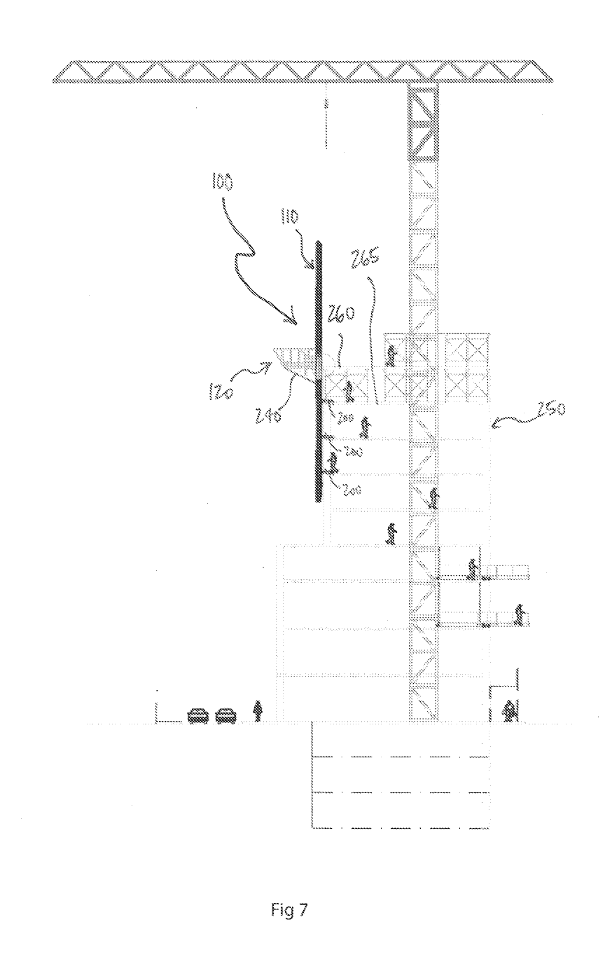

FIG. 7 shows a hoist car assembly 120 located above the uppermost level of support on a building 250. In this preferred embodiment, the hoisting device has an advantage over conventional formwork hoists, in which use of the hoist car is limited to servicing floors at or below the last level of support. This delays construction because the concrete slab for the floor above must attain full strength before the hoist car can service that level. Therefore, formwork materials cannot be transferred to that level until the slab has reached full strength.

The preferred embodiment 100 permits the hoist car assembly 120 access to a “green” slab 260 for transfer of materials in preparation for commencing formwork to freshly poured slabs before they have attained full strength. This is enabled by the use of a bracing member 240 to support the hoist car assembly 120 from its underside, so that a retaining shoe 200 is not required (circle highlights the absence of a retaining shoe on level 260). FIG. 7 shows a building 250 with a freshly poured or “green” slab 260 on the uppermost level (current roof level). No retaining shoe secures the guide rail 110 at this level 260. The embodiment relies on the floor below (item 265) for strength and retention of the hoist car assembly 120 and guide rail 110. In this embodiment, the drive system for the hoisting device (see item 270 in FIG. 2) also acts as a counterbalance to a load on the back car portion, the counterbalance being provided from below the hoist car.

Access to the slab is available once the edge boards are removed, accelerating the transfer of formwork or other construction materials for forming the next level. Once the green slab 260 achieves the desired strength, the retaining shoes 200 are put in place and secured to each guide rail 110.

This embodiment has an advantage over conventional formwork hoists that require bracing between two support levels to support the load of the hoist car. This prevents access of the hoist car to green slabs, because of the need to rely on a retaining shoe to secure the device to the building and support the loads imposed on the device.

The preferred embodiments therefore provide a number of cost and time-saving advantages, including one or more of the following:

(a) eliminating the need for cutting and re-welding of the guide rails;

(b) allowing the transfer of materials along floors of buildings that do not follow a vertical line, such as buildings having a sloped or irregularly-shaped face; and

(c) allowing the hoist car to access “green” slabs that are yet to attain full strength.

Although the invention has been described with reference to specific examples, it will be appreciated by those skilled in the art that the invention may be embodied in many different other forms.

1. A hoisting device for transferring formwork and other construction materials between levels of a multilevel building, the hoisting device including:
(a) a pair of substantially parallel guide rails capable of being secured to a multilevel building so that the guide rails span one or more levels of a building along its height; wherein each guide rail comprises two or more rail sections joined end to end, wherein adjacent rail sections are joined by a reversible connection assembly, thereby allowing the length of the guide rail to be reversibly adjusted by adjusting the number of rail sections joined to form the respective guide rail; and
(b) a hoist car assembly mounted on said the pair of guide rails, wherein the hoist car assembly is slidingly engaged with the guide rails such that the hoist car assembly is moveable along the building height.

2. A hoisting device for transferring formwork and other construction materials between levels of a multilevel building, the hoisting device including:
(a) a pair of substantially parallel guide rails,
wherein each guide rail comprises two or more rail sections joined end to end, wherein adjacent rail sections are joined by a reversible connection assembly, thereby allowing the length of the guide rail to be reversibly adjusted by adjusting the number of rail sections joined to form the respective guide rail, the guide rail being configured to span one or more levels of a building along its height;
(b) a hoist car assembly mounted on the pair of guide rails, wherein the hoist car assembly is slidingly engaged with the guide rails such that the hoist car assembly is moveable along the building height; and
(c) a securing element for securing each guide rail to a building, wherein the securing element enables pivotal engagement of each guide rail relative to the building such that the guide rail is adjustable between a substantially vertical position and an inclined position, the inclined position being at an angle to the vertical such that the hoisting device is capable of operating in an inclined position.

3. A hoisting device according to claim 1 or claim 2, wherein each rail section includes:
(a) an I-beam; and
(b) a box girder secured to the I-beam wherein the I-beam has two flanges separated by a web, and wherein the box girder is secured along one flange of the I-beam such that the box girder and I-beam are secured to each other along their respective longest dimensions, thereby forming a rail section.

4. A hoisting device according to claim 1 or claim 2, wherein the reversible connection assembly includes:
(a) a spigot inserting into the adjacent ends of two rail sections to be joined end to end; and
(b) a retaining plate bridging the joined ends of the adjacent rail sections to retain the joined ends together, wherein the retaining plate is reversibly secured to the adjacent rail sections by retaining plate securing means.

5. A hoisting device according to claim 4, wherein the spigot inserts into adjacent ends of adjacent box girders to secure the box girders of adjacent rail sections together.

6. A hoisting device according to claim claim 5, wherein the retaining plate bridges adjacent webs of adjacent I-beams to secure the I-beams of adjacent rail sections together.

7. A hoisting device according to claim 4, wherein the retaining plate securing means is countersunk within the adjacent webs of adjacent rail sections to permit smooth passage of the hoist car assembly across the reversible connection assembly.

8. A hoisting device according to claim 1, wherein the hoisting device further includes a securing element for securing the guide rails of the device to a building.

9. A hoisting device according to claim 2, wherein the securing element includes a plurality of retaining shoes spaced at intervals along each guide rail, each retaining shoe having a perimetral portion capable of being secured to the perimeter edge of a concrete slab in a building.

10. A hoisting device according to claim 9, wherein the securing element further includes a shoe clamp plate at the perimetral portion of the retaining shoe capable of securing to the guide rail,
wherein the shoe clamp plate is adjustable relative to the retaining shoe such that the guide rail is adjustable between a substantially vertical position and an inclined position, the inclined position being at an angle to the vertical such that the hoisting device is capable of operating in an inclined position.

11. A hoisting device according to claim 10 wherein the shoe clamp plate is pivotally engaged with the retaining shoe such that pivoting the shoe clamp plate relative to the retaining shoe enables the guide rail to be adjusted between a substantially vertical position and an inclined position.

12. A hoisting device according to claim 1 or claim 2 wherein the hoist car assembly includes:
(a) a hoist car having a front car portion, a back car portion and a floor, the front car portion being the portion of the hoist car closest to a building when the hoisting device is installed for use, the back car portion being the portion of the hoist car extending furthest from the building, and the floor extending from the front car portion to the back car portion;
(b) a pair of mast members on each side of the hoist car at the front car portion, wherein the hoist car is mounted on the mast members, and wherein the mast members are slidingly engaged with the guide rails such that sliding movement of the mast members relative to the guide rails enables the hoist car to travel along the guide rails.

13. A hoisting device according to claim 1 or claim 2 wherein the hoisting device includes a bracing member underneath the hoist car underside, to support the back car portion of the hoist car from below such that the car is able to travel along the guide rails beyond the uppermost level of support on a building.

14. A hoisting device according to claim 13 wherein the bracing member is a beam having two ends, and
wherein one end of the bracing member is secured to the back portion of the hoist car, on the underside of the hoist car, and the other end of the bracing member is secured to a mast member.

15. A hoisting device according to claim 1 or claim 2 wherein the hoist car is capable of being reversibly tilted relative to the guide rails such that the hoist car is able to remain substantially parallel with the building floor when the guide rails are in the inclined position.

16. A hoisting device according to claim 14 wherein the hoist car is pivotally engaged relative to the guide rails such that pivoting of the hoist car relative to the guide rails enables the hoist car to remain substantially parallel with the building floor.

17. A hoisting device according to claim or claim 2, wherein the device includes mechanical operation means to allow mechanical movement of the car along the guide rails.

18. A hoisting device according to claim 17 wherein the mechanical operation means is a motor drive.

19. A hoisting device according to claim 18 wherein the mechanical operation means can be operated remotely.

20. (canceled)
